(19) United States
(12) Patent Application Publication
(10) Pub. No.: US 2014/0081693 A1
(43) Pub. Date: Mar. 20, 2014

(54) SYSTEM AND METHOD CONFIGURED TO AUTOMATICALLY INVITE PARTICIPANTS TO A MEETING BASED ON RELATION TO MEETING MATERIALS

(71) Applicant: INTERNATIONAL BUSINESS MACHINES CORPORATION, Armonk, NY (US)

(72) Inventors: Kelly Abuelsaad, Poughkeepsie, NY (US); Kulvir S. Bhogal, Fort Worth, TX (US); Lisa Seacat DeLuca, San Francisco, CA (US); Soobaek Jang, Hamden, CT (US)

(73) Assignee: International Business Machines Corporation, Armonk, NY (US)

(21) Appl. No.: 13/622,090

(22) Filed: Sep. 18, 2012

(51) Int. Cl. G06Q 10/06

(52) U.S. Cl. 705/7.19

(57) ABSTRACT

Disclosed herein are a computer-implemented method, computer program and system to invite one or more people to a meeting. The method includes, in response to a user identifying one or more documents related to a meeting, analyzing the one or more documents to identify a name or names of people associated with the one or more documents; attempting to locate at least some of the identified people, such as in one or both of a database and a social network space, in order to obtain additional information regarding the at least some of the identified people; and presenting the user with a list of located identified people, the list being a list of people who are suggested to the user to be invited to the meeting.

### TECHNICAL FIELD

The exemplary embodiments of this invention relate generally to data processing systems, methods and computer programs and, more specifically, relates to an automated system, method and computer program to generate a list of potential meeting participants based on documentation related to a meeting.

### BACKGROUND

Of the numerous meetings conducted worldwide on a daily basis, many of these meetings are centered around an analysis of, or at least a discussion of, one or more documents. For example, a product development team may hold a meeting to review a design document in which many members of the development team, and possibly others, have collaborated. As another example, a group may hold a meeting to review an architecture document covering many different components, developed by several different architects. Further by example, an intellectual property board can hold a meeting to review several different invention disclosure documents authored and/or submitted to the board by several different inventors and/or groups of co-inventors.

A problem that arises in these scenarios and similar scenarios is that it can be a time-consuming task to determine and locate various authors of documents and other people related to the documents in order to invite them to the meeting. This problem can be further compounded in a case where more than one document, with several different authors each, is scheduled for discussion during a meeting.

### SUMMARY

In a first aspect thereof the examples of the embodiments of this invention provide a computer-implemented method to invite one or more people to a meeting. The method comprises, in response to a user identifying one or more documents related to a meeting, analyzing the one or more documents to identify a name or names of people associated with the one or more documents; attempting to locate at least some of the identified people in order to obtain additional information regarding the at least some of the identified people; and presenting the user with a list comprising identified people, the list being a list of people who are suggested to the user to be invited to the meeting.

In another aspect thereof the examples of the embodiments of this invention provide a computer-readable medium that stores computer software instructions. Execution of the computer software instructions by at least one data processor results in execution of operations that comprise, in response to a user identifying one or more documents related to a meeting, analyzing the one or more documents to identify a name or names of people associated with the one or more documents; attempting to locate at least some of the identified people in order to obtain additional information regarding the at least some of the identified people; and presenting the user with a list comprising identified people, the list being a list of people who are suggested to the user to be invited to the meeting.

### BRIEF DESCRIPTION OF THE SEVERAL VIEWS OF THE DRAWINGS

FIG. 1 shows an overall block diagram of a data processing system that is one suitable embodiment of a platform for implementing this invention.

FIG. 2 illustrates an example of a process flow in accordance with embodiments of this invention.

FIG. 3 is a simplified logic flow diagram in accordance with embodiments of this invention.

### DETAILED DESCRIPTION:

The exemplary embodiments of this invention address the various problems noted above by providing a system, method and computer program(s) to enable an automated technique to facilitate identifying people associated with documents, such as document authors, that are related to a meeting to be scheduled and to facilitate inviting some or all of the identified people to participate in the meeting.

As employed herein a meeting can be a traditional face-to-face gathering of two or more people (meeting participants) that is conducted at a certain location such as, by example, a conference room, an office, a restaurant, or any location conducive to providing an assembly location for two or more meeting participants. A meeting can also be a “virtual” meeting between participants, such as one conducted by conference call, or on-line by using text and/or video conferencing facilities. A meeting can also be a hybrid gathering of meeting participants where two or more participants are convened at the same location and where one or more other participants are at some remote location and join the meeting via telephone and/or by a data communications network such as the internet.

As employed herein a document can be any assemblage of human-comprehensible information such as text (e.g., alphanumeric character strings) representing any human-spoken language, and/or some computer program language, and/or some type of image data (e.g., a captured still image, a captured video, a computer-generated still image or video or a computer-processed still image or video), and/or audio data (e.g., recorded sound such as speech or music or computer-generated sound such as computer generated speech or music, or computer-processed recorded sound such as speech or music) that is conducive to being created in and/or converted to, represented in, stored as and transmitted by some type of digital format. In the context of this invention a document is preferably in a form that can be electronically “attached” in some manner to an electronic communication, such as an email communication. A particular document may be represented as one or more files in a file system of a computer can be stored electronically in a memory associated with the computer or that comprises a part of the computer. Non-limiting examples of documents include word processing documents, spreadsheets, and documents produced by or in cooperation with computer assisted drafting programs such as architectural diagrams and schematic circuit diagrams. A document could contain, for example, a listing of sequences found as part of a DNA molecule. A document could contain, for example, a business plan or an investment plan or a plan for a public works project. A document could contain, for example, the voice or voices and/or a video recording of one or several people. A document could contain, for example, an audio and/or a still image and/or a video recording made from nature (e.g., mammals or birds in their natural habitat, an image made through a telescope or a microscope) possibly supplemented with the recorded voice and/or an image of one or more people. It should thus be appreciated that, in general, a document can be any combination of the foregoing types of information and/or other types of representations of information that is conducive to being created in and/or converted to, represented in, stored as and transmitted in some type of digital format. As employed herein a document, whatever form it takes or whatever the content, can be considered as representing a reason to convene two or more people for a meeting, or to represent a subject of discussion for two or more people during a meeting.

As employed herein an author, or a potential author, can be a person somehow identified with a document. For example, in some cases an author of a document can be explicitly identified in the document as being an author or a co-author of the document, while in other cases this type of information may be inferable from the document. A particular document may have a single author or may have a multitude of authors. Note that to be considered as an author of a document a certain person may have actually created the document or assisted in the creation of the document. Alternatively a certain person may not have participated in any respect in the actual creation of the document. As but one non-limiting example, in one scenario a senior scientist, researcher, software programmer, business analyst or other type of knowledge worker may conceive of an idea or some content (e.g., text, image, audio) embodied in a document, but the actual document may have been created by one or more other people working under the direct or indirect guidance of the senior scientist, researcher, software programmer, business analyst or other knowledge worker. In this case the one or more other people may or may not also be denoted as authors of the document.

The present invention provides a system and method for discovering authors, owners, and other related people of one or more documents to be discussed during the meeting. A suggested invitee list to a meeting can be automatically generated by searching a document to identify one or more people, such as authors and/or document owners that are relevant to the materials to be discussed.

With specific regard to an “owner” of a document it can be noted that different corporations and organizations have different titles and meanings of the titles that they associate with a document. These titles and meanings can have different implications. The specifics of these titles and the like, and their meanings, are not particularly germane to the operation of this invention, so long as the inventive system and methods have the ability to extract them from a document and attach the associated title to the user's name when presenting it to the person who is creating the meeting invite. The title may explicitly be defined in the document, i.e., “Document Owner: John Doe” is written in the document itself Alternatively, and as a part of this invention, the user who is running this application can set up some pre-defined rules, customized to their organization, to be able to imply a title to a user. For example, perhaps the document was uploaded to an online repository. The document owner could be implied as the person who uploaded the document to the repository, even though their name may not be mentioned in the document. Again, the document ‘owner’ title itself is not important, as a non-limiting aspect of the invention is an ability to recognize explicitly defined titles or to imply titles based on, for example, a customized rule that the user defines ahead of time.

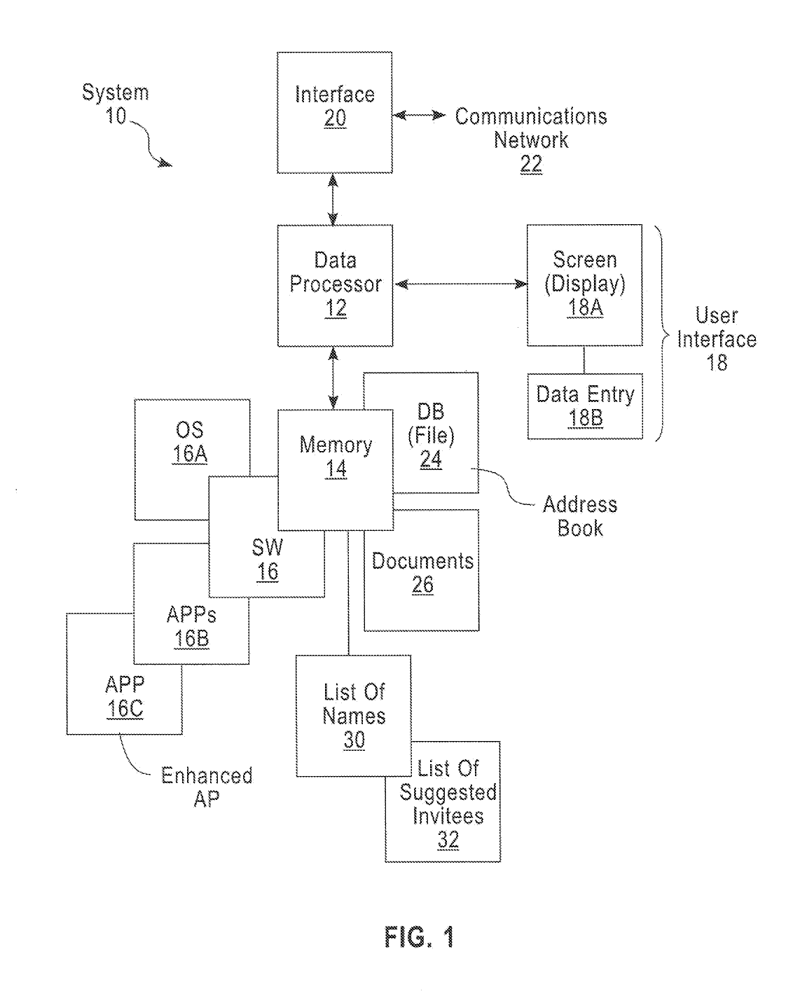

FIG. 1 shows an overall block diagram of a data processing system 10 that is one suitable embodiment of a platform for implementing this invention. The data processing system 10 includes at least one data processor (DP) 12 embodied as, for example, a central processing unit (CPU), a server, or as a virtual machine (VM) such as in a cloud-based instantiation of the system 10. In general, the system can be embodied as a ‘real machine’ comprising the at least one data processor connected with at least one memory (e.g., as a desk top or a lap-top or as a tablet embodiment) or it can be embodied as a virtual machine in a cloud-based data processing environment.

Connected with the data processor 12 is at least one computer readable medium or computer readable storage medium such as one represented by a memory 14. The memory 14 can be composed of disk-based memory and/or semiconductor-based memory and/or any suitable type of data/program storage memory. Stored in the memory 14 is software (SW) 16 such as an operating system (OS) 16A and applications (APPs) 16B. One of the applications 16B can be a software program 16C that, when executed by the at least one data processor 12, results in the performance of methods in accordance with this invention. Also connected with the data processor 12 is some type of user interface (UI) 18 such one having a display screen 18A and a data entry device 18B such as a keyboard or a touch screen interface. Also connected with the data processor 12 is some type of interface 20 to a data communications network 22. The network 22 could be represented as a local area network (LAN), and/or as a wireless LAN (WLAN), and/or as a wide area network (WAN) such as the internet.

The system 10 could take any number of forms, from a desk top PC to a tablet-type device to a mobile wireless communication device to a server to a mainframe computer, as non-limiting examples. In some embodiments the UI 18 could form a part of the system 10, e.g., where the system is embodied as a stand-alone PC or tablet, while in other embodiments the UI 18 could be represented as a terminal through which a user is enabled to log-in to the system 10 and interact with the SW 16, e.g., where the system 10 is embodied as a server or a VM in a cloud-based instantiation.

Also shown stored in memory 14 is a database or simply a file 24 of names of people and associated information such as contact information (e.g., email address(es), telephone number(s), etc.) The file 24 could be an address book type of collection of data for a particular organization or enterprise (e.g., it could be a corporate address book). The file 24 could be locally stored in the memory 14 of the system 10 as shown, or the file 24 could be remotely stored and accessed via the interface 20 and the data communications network 22.

Note that in some embodiments the database or file 24 may not be used. Instead, and by example, the names of people and associated information could be locatable in a social network space via some third party service or application program interface (API). In some embodiments a lightweight directory access protocol (LDAP) or some other source of information can be used. In general, when attempting to locate at least some of the identified people in order to obtain additional information regarding the at least some of the identified people any on-line or locally accessible database, or any on-line source of information can be used.

Also shown stored in memory 14 are documents 26. The documents 26 could be locally stored in the memory 14 of the system 10 as shown, or the documents 26 could be remotely stored and accessed via the interface 20 and the data communications network 22. In some embodiments the file 24 (e.g., address book) could be stored in one remote database and the documents 26 could be stored in one or more other remote databases.

One of the APPs 16B could be an application program that allows a user to compose and email invitations (e.g., meeting invitations) to other people. In this case the meeting invitation application program can interact with the SW program 16C. In another embodiment the application program that allows a user to compose and email meeting invitations could be modified to include the functionality of the SW program 16C, e.g., the SW program 16C is an enhanced application program that allows a user to compose and email meeting invitations while also searching documents to determine authors names as described in further detail below.

Meeting invitations once composed can be sent to the meeting invitees via the interface 20 and communications network 22. Note that a meeting invitation could include a notification that the invitation was composed using the SW program 16C, such as the enhanced application program that allows a user to compose and email meeting invitations. The meeting invitee can then ascertain that he or she was invited to the meeting because of some association with a document to be discussed at the meeting. The document or documents to be discussed may be electronically attached to the meeting invitation, or an electronic link to the document or documents can be included in the meeting invitation. The recipients of the meeting invitation may reply electronically to indicate whether or not they will attend or otherwise participate in the meeting.

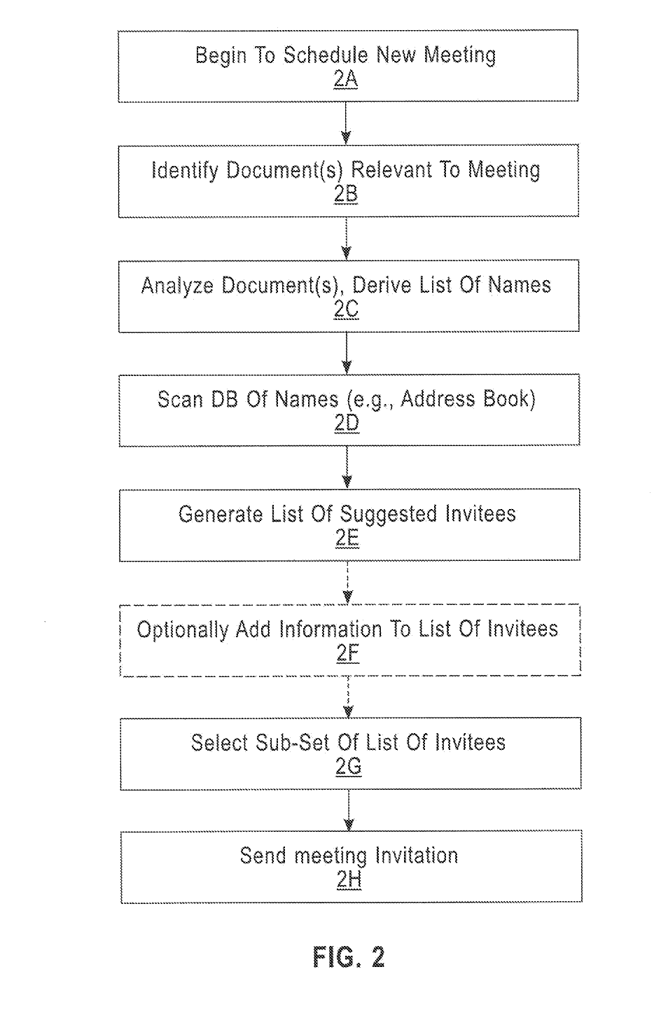

FIG. 2 illustrates an example of a process flow in accordance with embodiments of this invention.

2A. A meeting coordinator acting as a user begins, such as via the UI 18, to schedule a new meeting using the electronic invitation SW (enhanced application program 16C). Note that the meeting coordinator need not be a person who will actually attend a scheduled meeting.

2B. The meeting coordinator can attach materials, such as one or more of the documents 26, to the meeting invitation. The attached document/documents 26 could be, for example, a word processing document, a presentation, an architectural diagram, and/or a hyperlink to a website/wiki. Alternatively the meeting coordinator could create a list containing one or more documents but not yet actually attach them at this point to a meeting invitation.

2C. The enhanced application program 16C analyzes the text of the attached (listed) document(s) and searches for names of people. The enhanced application program 16C can use tagging or more sophisticated analytical techniques when parsing the document(s) to find the names of, for example:

a. Document authors;

b. Document business or technical owners;

c. Document reviewers;

d. Any other person or people deemed to relate to the document. This can be accomplished by performing analytics on the document text. In general this can encompass identifying a person mentioned in or related in some way to the document. As one non-limiting example a document may be or may include an image of Person A that was created or captured by Person B. In this case it could be desirable to identify and invite the author of the image (Person B) as well as the subject of the image (Person A).

In some cases the document author(s) may be explicitly identified at the beginning or at the end of the document. In some other cases the document author(s) may not be explicitly identified.

2D. After deriving a list of names 30, the enhanced application program 16C may then scan the file 24 containing, for example, employee data (e.g., the corporate address book) and attempt to match the entries in the list of names 30 with employees. This can involve resolving differences in names (e.g., proper names vs. nicknames, fully spelling out a middle name vs. abbreviating the middle name). If this is not successful or only partially successful the enhanced application program 16C may search for and consult other sources such as professional or personal social networking sites, on-line biographies of people, other publications/documents of which the person may be an author/co-author, etc. For example, a particular person whose name is associated with a document might be a contractor in the employ of a corporation, and the enhanced application program 16C may locate additional information (including contact information) by searching for the person's name in some listing published on-line by a professional organization or by the actual employer of the contractor.

As was noted above the use of the file 24 can be optional and instead the enhanced application program 16C may only attempt to locate a person in some social network space or spaces. In general, the enhanced application program 16C attempts to locate at least some of the identified people in one or both of a database or databases and a social network space or spaces in order to obtain additional information, such as email address, title, etc., regarding the at least some of the identified people. Note that in some cases all relevant information may be found in the document, such as when a person is explicitly cited as being an author, and where other information regarding the person such as an email address, title and possibly a biography is also explicitly given. In this case the enhanced application program 16C is enabled to extract all relevant information from the document itself and may not need to consult other sources in an attempt to locate this information.

The enhanced application program 16C can also add people to the list of names 30 that are linked in some manner to the found people, where the linkage can be one or more of the following: in a technical group related to one or more of the people in the set, and/or associated with a manager, a social network connection or a recommendation made by a person in the set, as non-limiting examples. Related to this is the example given above where Person B creates or captures an image of Person A. In this case the Person A can be considered as being linked (as subject) to Person B (as author).

2E. Based on the matching entries in the list of names 30 the enhanced application program 16C generates a list of suggested invitees 32 to the meeting.

2F. Optionally when composing the list of suggested invitees 32 the enhanced application program 16C can tag each name with information related to what role that person potentially plays with respect to a document, so that when the meeting coordinator reviews the list of suggested invitees 32 the meeting coordinator can be informed of their possible level of involvement with the document. Non-limiting examples include:

a. Whole document author/co-author

b. Business owner

c. Author of only a section entitled: “How to install the application”

d. Reviewer of the document

This tagging of the names can be based on any available information and meta-data found in the document itself or found external to the document (e.g., in the address book 24). This additional information/meta-data could include, but is not limited to, a title associated with the person's name (e.g., Senior Scientist, Researcher, Analyst, Vice President of Technology, etc.) in the address book 24, or expressly stated in the document itself, or stated or inferred from some other source such as a personal or professional social networking site in which the person has an entry/presence.

2G. Based on the list of suggested invitees 32, possibly augmented with the additional information such as the person's potential level of involvement with the document to be discussed during the meeting, the meeting coordinator can review the list and select a sub-set of the list of suggested invitees 32 to actually send the electronic meeting invitation to. Alternatively, the enhanced application program 16C can perform all or a part of this review based on some pre-programmed rules, such as ‘invite all identified people if there are fewer than n people listed’, or ‘invite only those identified people specifically designated in the document(s) as being an author or a co-author’, etc.

2H. The meeting coordinator, or the enhanced application program 16C itself autonomously, sends the meeting invitation electronically to the people in the list of suggested invitees 32. If not yet done the relevant ones of the document(s) 26 to be discussed at the meeting can be attached at this time to the meeting invitation.

The foregoing embodiments can be extended to cover, beyond calendar invitations, email and other types of electronic communication creation (e.g., filling in To, CC, BCC fields).

The embodiments of this invention provide a method and system locating a set of people associated with one or more documents; presenting a user (e.g., the meeting coordinator) with the located set of people; and enabling the user to select and/or de-select people from the set to create a selected subset of people.

In the system and method the selected subset of people is used as a list of invitees to a meeting.

In the system and method the selected subset of people is used to identify addressees of an electronic communication.

In the system and method the set of people can change if a document is added or deleted.

In the system and method there can be an additional operation of adding people to the set that are linked in some manner to people in the set, where the linkage can be, for example, one or more of the following: in a technical group related to one or more of the people in the set, and/or associated with a manager, a social network connection or a recommendation made by a person in the set.

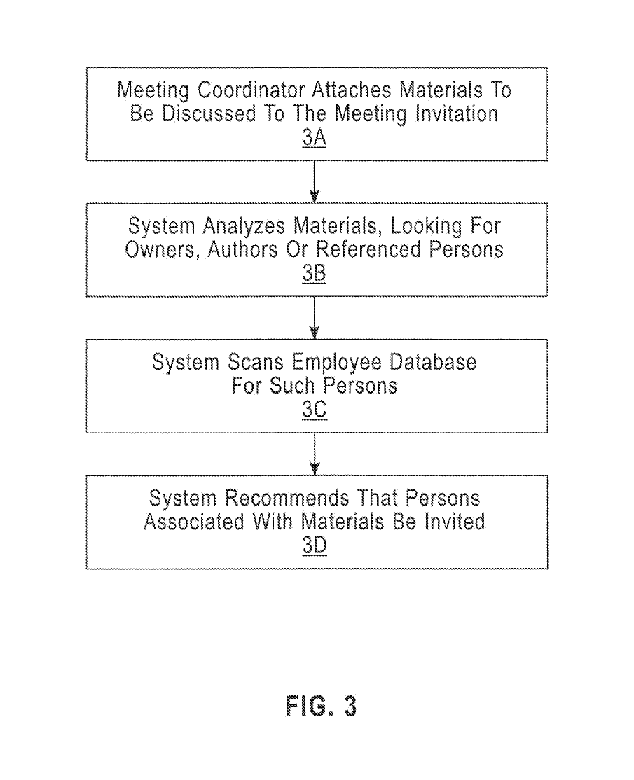

FIG. 3 is a simplified logic flow diagram in accordance with embodiments of this invention. In Block 3A a meeting coordinator attaches materials (e.g., documents) to a meeting invitation. At Block 3B the system 10 analyzes the attached materials, looking for owners, authors or referenced people of the materials. At Block 3C the system scans a database, e.g., an employee database, to locate such people and/or the system can scan one or more social network sites to locate such people. At Block 3D the system recommends that at least some people associated with the materials be invited to the meeting.

It is also within the scope of the exemplary embodiments of this invention to enable a user to “filter out” potential meeting invitees. For example, the user may declare to the application: “I would like to only invite people who actually authored the document”, or “I would like to only invite people who are identified as ‘software engineers’, and who are related to the document”, or, “Automatically select those people having a highest probability of being directly related to the document”. In general, an aspect of this invention provides an ability to automatically filter potential invitees by the use of one or more filter parameters that can be defined/selected by the user who is organizing a meeting.

It is also within the scope of the exemplary embodiments of this invention to automatically delete an invitee or invitees from the meeting if, for example, there are two or more documents to be discussed in or related to the meeting, but then one of the documents that an author, owner, etc. is associated with is removed from the meeting agenda. In this case any people identified with just the removed document can be automatically deleted from the list of potential invitees. Alternatively those names can be highlighted or otherwise indicated in some way so that the user who is organizing the meeting has the option to (manually) delete them from the list of meeting invitees.

It is also within the scope of the exemplary embodiments of this invention to provide the user with pre-defined implied roles of associated people if not explicitly labeled in the document, prior to inspecting the document. For example, a document author or document owner could be defined as someone who last updated, saved or created the document according to meta-data associated with the document, but not appearing in the actual document text itself For example, in a word processing document a person's name may be listed under the ‘properties’ of the document as a creator, but not in the actual document text. Further by example, if a document was uploaded to a file repository, and the meeting invite contains a hyperlink to that document, the person identified as being the person who uploaded the document could be defined as one of the document owners. In these various cases then the use of the embodiments of this invention enable the system and method, when analyzing documents to identify a name of a person to be invited to the meeting, and whose name does not explicitly appear in a document, to be identified using some type of meta-data associated with the document. This meta-data can comprise, as non-limiting examples, data indicating the person as a creator of the document, or as a person who last saved the document, or as a person who last updated the document, or as a person who transmitted the document through some type of network such as when uploading the document to a file repository.

As should be appreciated, the use of this invention enables a person (e.g., a meeting coordinator who is a user of the application and system provided by this invention) to simply identify a document or documents to be discussed at a meeting to be held, at which point the system 10 at least determines a list of potential meeting attendees based on the identified document(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a ‘circuit’, ‘module’ or ‘system’. Furthermore, aspects of the present invention may take the form of a computer program product embodied in one or more computer readable medium(s) having computer readable program code embodied thereon.

In a non-limiting aspect thereof the examples of the embodiments of this invention provide a data processing system configured to invite one or more people to a meeting. The data processing system includes at least one data processor connected with at least one memory/computer readable medium storing computer program code. Execution of the computer program code by the at least one data processor results in operations being performed that comprise, in response to a user identifying one or more documents related to a meeting, analyzing the one or more documents to identify a name or names of people associated with the one or more documents; attempting to locate at least some of the identified people in order to obtain additional information regarding the at least some of the identified people; and presenting the user with a list comprising identified people, the list being a list of people who are suggested to the user to be invited to the meeting.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent mathematical expressions may be used by those skilled in the art. However, all such and similar modifications of the teachings of this invention will still fall within the scope of this invention.

What is claimed is:

1. A computer-implemented method to invite one or more people to a meeting, comprising:
in response to a user identifying one or more documents related to a meeting, analyzing the one or more documents to identify a name or names of people associated with the one or more documents;
attempting to locate at least some of the identified people in order to obtain additional information regarding the at least some of the identified people; and
presenting the user with a list comprising identified people, the list being a list of people who are suggested to the user to be invited to the meeting.

2. The method as in claim 1, where the user identifies the one or more documents related to the meeting by attaching, or making reference to, the one or more documents in an electronic meeting invitation.

3. The method as in claim 1, where analyzing comprises attempting to identify an author or a co-author of all or a part of a document.

4. The method as in claim 1, where analyzing comprises attempting to identify at least one of an owner of a document, a reviewer of a document, and a person mentioned in or related in some way to the document.

5. The method as in claim 1, where presenting the user with a list comprising identified people also presents the user with an address at which an identified person can be contacted to receive an electronic meeting invitation.

6. The method as in claim 1, where presenting the user with a list comprising identified people also presents the user with information related to a potential relevance of the identified person to a document.

7. The method as in claim 1, further comprising enabling the user to define at least one filter parameter that is used to automatically filter people who are potential meeting invitees.

8. The method as in claim 1, further comprising automatically deleting from the list of people, who are suggested to the user to be invited to the meeting, a person or people associated with a document that is removed from a list of documents to be discussed at the meeting.

9. The method as in claim 1, further comprising indicating to the user a person, appearing in the list of people who are suggested to the user to be invited to the meeting, that is associated with a document that is removed from a list of documents to be discussed at the meeting.

10. The method as in claim 1, where analyzing further comprises identifying a name of a person to be invited to the meeting, whose name does not explicitly appear in a document, using meta-data associated with the document.

11. The method as in claim 1, further comprising sending a meeting invitation to at least some of the identified people, where the meeting invitation includes information to enable a recipient of the meeting invitation to ascertain that they are invited due to having some association with a document related to the meeting.

12. The method of claim 1, where the step of attempting to locate uses one or both of a local or an on-line database and a social network space.

13. The method as in claim 1, performed in response to an execution of computer software stored in a computer-readable medium by a data processor associated with a central processing unit or with a virtual machine.

14. A computer-readable medium that stores computer software instructions, where execution of the computer software instructions by at least one data processor results in execution of operations that comprise:
in response to a user identifying one or more documents related to a meeting, analyzing the one or more documents to identify a name or names of people associated with the one or more documents;
attempting to locate at least some of the identified people in order to obtain additional information regarding the at least some of the identified people; and
presenting the user with a list of comprising identified people, the list being a list of people who are suggested to the user to be invited to the meeting.

15. The computer-readable medium as in claim 14, where the user identifies the one or more documents related to the meeting by attaching the one or more documents to an electronic meeting invitation.

16. The computer-readable medium as in claim 14, where analyzing comprises attempting to identify an author or a co-author of all or a part of a document.

17. The computer-readable medium as in claim 14, where analyzing comprises attempting to identify at least one of an owner of a document, a reviewer of a document, and a person related in some way to the document.

18. The computer-readable medium as in claim 14, where presenting the user with a list comprising identified people also presents the user with an address at which an identified person can be contacted to receive an electronic meeting invitation.

19. The computer-readable medium as in claim 14, where presenting the user with a list comprising identified people also presents the user with information related to a potential relevance of the identified person to a document.

20. The computer-readable medium as in claim 14, further comprising an operation of enabling the user to define at least one filter parameter that is used to automatically filter people who are potential meeting invitees.

21. The computer-readable medium as in claim 14, further comprising an operation of automatically deleting from the list of people who are suggested to the user to be invited to the meeting a person or people associated with a document that is removed from a list of documents to be discussed at the meeting.

22. The computer-readable medium as in claim 14, further comprising an operation of indicating to the user a person, appearing in the list of people who are suggested to the user to be invited to the meeting, that is associated with a document that is removed from a list of documents to be discussed at the meeting.

23. The computer-readable medium as in claim 14, where the operation of analyzing further comprises an operation of identifying a name of a person to be invited to the meeting, whose name does not explicitly appear in a document, using meta-data associated with the document.

24. The computer-readable medium as in claim 14, further comprising an operation of sending a meeting invitation to at least some of the identified people, where the meeting invitation includes information to enable a recipient of the meeting invitation to ascertain that they are invited due to having some association with a document related to the meeting.

25. The computer-readable medium as in claim 14, where the operation of attempting to locate uses one or both of a local or an on-line database and a social network space, and where the at least one data processor is associated with a central processing unit or with a virtual machine.
